(19) United States
(12) Patent Application Publication
(10) Pub. No.: US 2026/0189619 A1
(43) Pub. Date: Jul. 2, 2026

(54) ADVANCED RECEIVER DIVERSITY TRIGGER FOR EXTENDED REALITY

(71) Applicant: QUALCOMM Incorporated, San Diego, CA (US)

(72) Inventors: Chih-Ping LI, San Diego, CA (US); Prashanth Haridas HANDE, San Diego, CA (US); Mickael MONDET, Louannec (FR); Ravi AGARWAL, San Diego, CA (US); Md Ibrahim KHALIL, San Diego, CA (US)

(21) Appl. No.: 19/003,917

(22) Filed: Dec. 27, 2024

(51) Int. Cl. H04L 65/80; H04L 65/1063; H04L 67/131

(52) U.S. Cl. CPC H04L 65/80; H04L 65/1063; H04L 67/131

(57) ABSTRACT

Methods, systems, and devices for wireless communications are described. A UE may obtain, via an application program interface (API), an indication of an application type of an application at the UE and information including an indication of performance requirements associated with the application, an indication of a traffic type associated with the application, an indication of whether the performance requirements are being met, an indication of quality of service (QoS) information associated with a packet data unit (PDU) session established for communication by the application, an indication of a network slice associated with the PDU session, an indication of a power consumption of the UE, an indication of whether a power budget of the UE is being met, or any combination thereof. The UE may communicate one or more wireless signals via a subset of multiple antennas of the UE based on the application type or the information.

### FIELD OF TECHNOLOGY

The following relates to wireless communications, including advanced receiver diversity (ARD) trigger for extended reality (XR).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a user equipment (UE) is described. The method may include obtaining, via an application program interface (API), an indication of an application type of an application at the UE and information including an indication of performance requirements associated with the application, an indication of a traffic type associated with the application, an indication of whether the performance requirements are being met, an indication of quality of service (QoS) information associated with a packet data unit (PDU) session established for communication by the application, an indication of a network slice associated with the PDU session, an indication of a power consumption of the UE, an indication of whether a power budget of the UE is being met, or any combination thereof and communicating one or more wireless signals via a subset of a set of multiple antennas of the UE, where the subset of the set of multiple antennas is activated for communication of the one or more wireless signals based on the application type being associated with an extended reality (XR) environment and the information.

A UE is described. The UE may include one or more memories storing processor executable code, and one or more processors coupled with the one or more memories. The one or more processors may individually or collectively be operable to execute the code to cause the UE to obtain, via an API, an indication of an application type of an application at the UE and information including an indication of performance requirements associated with the application, an indication of a traffic type associated with the application, an indication of whether the performance requirements are being met, an indication of QoS information associated with a PDU session established for communication by the application, an indication of a network slice associated with the PDU session, an indication of a power consumption of the UE, an indication of whether a power budget of the UE is being met, or any combination thereof and communicate one or more wireless signals via a subset of a set of multiple antennas of the UE, where the subset of the set of multiple antennas is activated for communication of the one or more wireless signals based on the application type being associated with an XR environment and the information.

Another UE is described. The UE may include means for obtaining, via an API, an indication of an application type of an application at the UE and information including an indication of performance requirements associated with the application, an indication of a traffic type associated with the application, an indication of whether the performance requirements are being met, an indication of QoS information associated with a PDU session established for communication by the application, an indication of a network slice associated with the PDU session, an indication of a power consumption of the UE, an indication of whether a power budget of the UE is being met, or any combination thereof and means for communicating one or more wireless signals via a subset of a set of multiple antennas of the UE, where the subset of the set of multiple antennas is activated for communication of the one or more wireless signals based on the application type being associated with an XR environment and the information.

A non-transitory computer-readable medium storing code is described. The code may include instructions executable by one or more processors to obtain, via an API, an indication of an application type of an application at the UE and information including an indication of performance requirements associated with the application, an indication of a traffic type associated with the application, an indication of whether the performance requirements are being met, an indication of QoS information associated with a PDU session established for communication by the application, an indication of a network slice associated with the PDU session, an indication of a power consumption of the UE, an indication of whether a power budget of the UE is being met, or any combination thereof and communicate one or more wireless signals via a subset of a set of multiple antennas of the UE, where the subset of the set of multiple antennas is activated for communication of the one or more wireless signals based on the application type being associated with an XR environment and the information.

In some examples of the method, UEs, and non-transitory computer-readable medium described herein, to obtaining the indication of the application type and the information may include operations, features, means, or instructions for obtaining, at an antenna manager via an interface established by the antenna manager, the indication of the application type or the indication of the performance requirements from the application.

In some examples of the method, UEs, and non-transitory computer-readable medium described herein, the performance requirements associated with the application include a throughput threshold or a latency threshold.

In some examples of the method, UEs, and non-transitory computer-readable medium described herein, to obtaining the information may include operations, features, means, or instructions for obtaining, from a modem of the UE, the indication of the traffic type or the indication of whether the performance requirements may be being met based on a metric associated with data traffic at the modem.

Some examples of the method, UEs, and non-transitory computer-readable medium described herein may further include operations, features, means, or instructions for updating, based at least in part on the performance requirements not being met, the subset of the set of multiple antennas to include one or more additional activated antennas, where communicating the one or more wireless signals may be based on updating the subset of the set of multiple antennas.

In some examples of the method, UEs, and non-transitory computer-readable medium described herein, to obtaining the information may include operations, features, means, or instructions for receiving the indication of the QoS information via a PDU session establishment message or a PDU session modification message.

Some examples of the method, UEs, and non-transitory computer-readable medium described herein may further include operations, features, means, or instructions for activating an antenna manager based on the indication of the QoS information, where communicating the one or more wireless signals via the subset of the set of multiple antennas may be based on activation of the antenna manager.

In some examples of the method, UEs, and non-transitory computer-readable medium described herein, to obtaining the information may include operations, features, means, or instructions for receiving the indication of the network slice via a PDU session establishment message or a PDU session modification message, where the indication of the network slice indicates a type of the network slice.

Some examples of the method, UEs, and non-transitory computer-readable medium described herein may further include operations, features, means, or instructions for activating an antenna manager based on the type of the network slice, where communicating the one or more wireless signals may be based on activation of the antenna manager.

In some examples of the method, UEs, and non-transitory computer-readable medium described herein, to obtaining the information may include operations, features, means, or instructions for obtaining, from a modem of the UE, the indication of the power consumption of the UE or the indication of whether the power budget of the UE may be being met.

In some examples of the method, UEs, and non-transitory computer-readable medium described herein, the UE may be associated with a set of multiple applications including the application and the application may be associated with a highest resource utilization of the set of multiple applications.

Some examples of the method, UEs, and non-transitory computer-readable medium described herein may further include operations, features, means, or instructions for activating an antenna manager based on the application type being associated with the XR environment, obtaining, via a second API, an indication of a second application type of a second application at the UE, and deactivating the antenna manager for communication of one or more second signals associated with the second application based on the second application type being associated with a non-XR environment.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports advanced receiver diversity (ARD) trigger for extended reality (XR) in accordance with one or more aspects of the present disclosure.

FIG. 2 shows an example of a wireless communications system that supports ARD trigger for XR in accordance with one or more aspects of the present disclosure.

FIG. 3 shows an example of a user equipment (UE) diagram that supports ARD trigger for XR in accordance with one or more aspects of the present disclosure.

FIG. 4 shows an example of a UE diagram that supports ARD trigger for XR in accordance with one or more aspects of the present disclosure.

FIGS. 5A and 5B shows an example of a wireless communications system that supports ARD trigger for XR in accordance with one or more aspects of the present disclosure.

FIG. 6 shows an example of a UE diagram that supports ARD trigger for XR in accordance with one or more aspects of the present disclosure.

FIG. 7 shows an example of a process flow that supports ARD trigger for XR in accordance with one or more aspects of the present disclosure.

FIGS. 8 and 9 show block diagrams of devices that support ARD trigger for XR in accordance with one or more aspects of the present disclosure.

FIG. 10 shows a block diagram of a communications manager that supports ARD trigger for XR in accordance with one or more aspects of the present disclosure.

FIG. 11 shows a diagram of a system including a device that supports ARD trigger for XR in accordance with one or more aspects of the present disclosure.

FIGS. 12 through 14 show flowcharts illustrating methods that support ARD trigger for XR in accordance with one or more aspects of the present disclosure.

### DETAILED DESCRIPTION

In some wireless communication systems, a user equipment (UE) may communicate with other wireless devices via multiple antennas. An antenna manager (e.g., an advanced radio diversity (ARD) manager) of the UE may switch between antenna configurations. For example, a first antenna configuration may include activation of a reduced quantity of antennas compared to a second antenna configuration. The first antenna configuration may reduce power consumption at the UE, and the second antenna configuration may provide reduced latency and increased throughput at the UE. The antenna manager may switch between the first antenna configuration and the second antenna configuration based on signaling from a network entity (e.g., a control message, an indication of a bandwidth part (BWP), or a downlink grant). In some examples, an application at the UE may benefit from higher throughput and lower latency. In some examples, a core network may output traffic information to the UE (e.g., quality of service (QoS) information or network slice information). The traffic information may indicate if a data flow benefits from higher throughput and lower latency. In some examples, a modem of the UE may obtain UE power consumption information. The power consumption information may indicate if the UE is meeting a power budget. It may be beneficial for the antenna manager to switch between antenna configurations based on the additional information provided by the application, a core network, or the modem. For example, the antenna manager may dynamically increase throughput, lower latency, or reduce power consumption based on one or more trigger conditions.

According to techniques described herein, an antenna manager of the UE may obtain information from an application, a core network, or a modem, and the antenna manager may activate a subset of multiple antennas based on the information. In some examples, the antenna manager may obtain an indication from the application of an application type associated with the application. The antenna manager may activate an increased quantity of the multiple antennas based on the application type being a performance-sensitive application type, or the antenna manager may activate a decreased quantity of the multiple antennas based on the application type not being a performance-sensitive application type. In some examples, the antenna manager may obtain an indication of QoS information associated with a data flow at the UE. The UE may activate or deactivate the antenna manager based on the QoS information, and the antenna manager may activate a subset of the multiple antennas based on the QoS information. In some examples, the antenna manager may obtain an indication that a UE power budget is not being met (e.g., from a power component of the modem or from the modem). The UE may activate a subset of the multiple antennas to reduce UE power consumption to meet the UE power consumption budget.

Particular aspects of the subject matter described in this disclosure may be implemented to realize one or more of the following potential advantages. In some examples, the UE may increase throughput and decrease latency by activating one or more additional antennas based on obtaining an indication that an application at the UE may benefit from additional throughput or decreased latency. In some examples, the UE may reduce power consumption at the UE by deactivating one or more antennas based on obtaining an indication that an application at the UE may sufficiently operate with a reduced quantity of antennas.

Aspects of the disclosure are initially described in the context of wireless communications systems. Additional aspects of the disclosure are described in the context of UE diagram or process flow. Aspects of the disclosure are further illustrated by and described with reference to apparatus diagrams, system diagrams, and flowcharts that relate to ARD trigger for extended reality (XR).

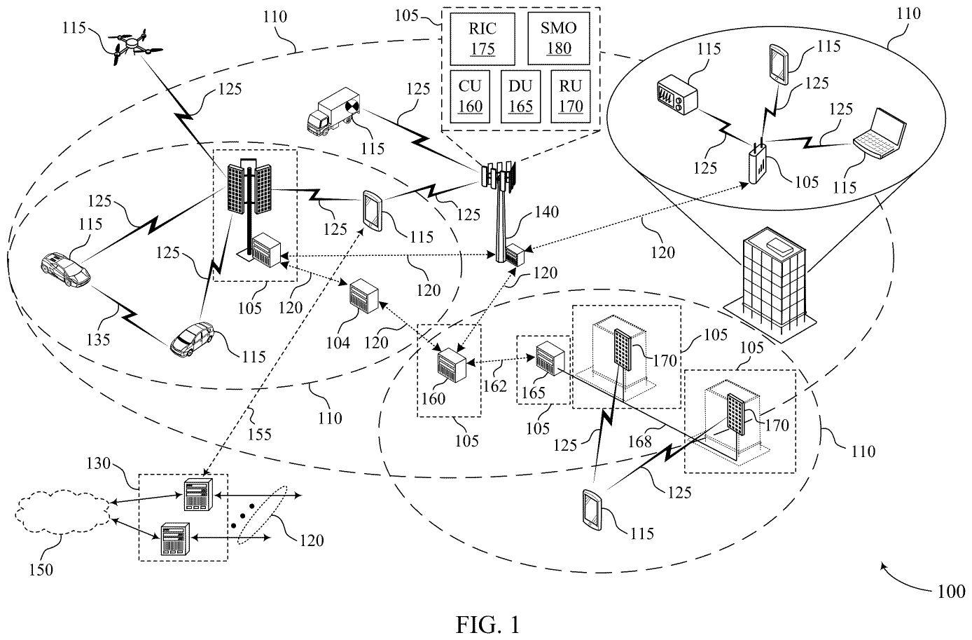

FIG. 1 shows an example of a wireless communications system 100 that supports ARD trigger for XR in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a 5G network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support ARD trigger for XR as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nf) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

According to techniques described herein, an antenna manager of the UE 115 may obtain information from an application, a core network, or a modem, and the antenna manager may activate a subset of the multiple antennas based on the information. In some examples, the antenna manager may obtain an indication from the application of an application type associated with the application. The antenna manager may activate an increased quantity of the multiple antennas based on the application type being a performance-sensitive application type, or the antenna manager may activate a decreased quantity of the multiple antennas based on the application type not being performance-sensitive application type. In some examples, the antenna manager may obtain an indication of QoS information associated with a data flow at the UE 115. The UE 115 may activate or deactivate the antenna manager based on the QoS information, and the antenna manager may activate a subset of the multiple antennas based on the QoS information. In some examples, the antenna manager may obtain an indication that a UE power budget is not being met (e.g., from a power component of the modem or from the modem). The UE 115 may activate a subset of the multiple antennas to reduce UE power consumption to meet the UE power consumption budget.

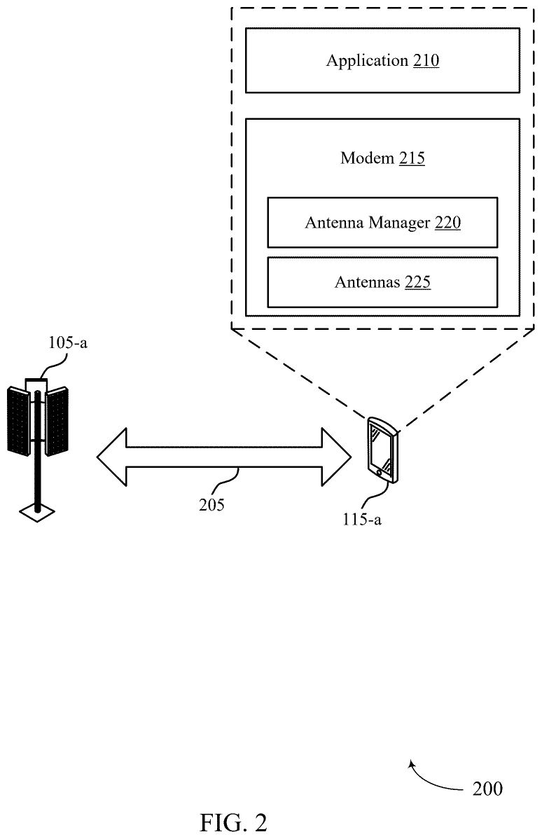

FIG. 2 shows an example of a wireless communications system 200 that supports ARD trigger for XR in accordance with one or more aspects of the present disclosure. For example, a UE 115-a may represent an example of a UE, such as the UEs 115 described with reference to FIG. 1. A network entity 105-a may represent an example of a network entity, such as the network entities 105 described with reference to FIG. 1. The UE 115-a may communicate with the network entity 105-a using one or more antennas and via a wireless communication link 205. The UE 115-a may execute an application 210. The UE 115-a may include a modem 215. In some examples, the modem 215 may include an antenna manager 220 (e.g., ARD manager) and antennas 225. Antennas 225 may include a quantity of antennas (e.g., 2 antennas, 4 antennas) or antenna panels, where each antenna or antenna panel may include circuitry for reception or transmission of signals (e.g., radio frequency front end (RFFE) circuitry such as amplifiers, filters, analog to digital converters (ADCs), digital to analog converters (DACs), phase control circuitry, and the like). The antenna manager 220 may activate one or more of the antennas 225 for wireless communication in accordance with an antenna configuration. In some examples, the antenna manager 220 or the antennas 225 may be separate from the modem 215.

In some wireless communications, the UE 115-a may support ARD (e.g., via the antenna manager 220). The ARD may enable the UE 115-a to switch between a reduced quantity of receive antennas (e.g., two receive antennas or 2RX) and a larger quantity of receive antennas (e.g., four receive antennas or 4RX). In some examples, the ARD may enable the UE 115-a to switch between one receive antenna (e.g., 1RX) and two receive antennas (e.g., 2RX) in a reduced capacity (Redcap) implementation. Although described in the context of receive antennas, it should be understood that the techniques described herein may apply to of the antennas 225 used for transmission, or reception and transmission at the UE 115-a.

The reduced quantity of receive antennas (e.g., 2RX) may save UE power and reduce UE power consumption. For example, the UE 115-a (e.g., via the antenna manager 220) may switch to the reduced quantity of receive antennas when UE traffic is light, which may be at the cost of higher latency. The larger quantity of receive antennas (e.g., 4RX) may enable high throughput at the UE 115-a and lower latency, which may be at the cost of power consumption.

The antenna manager 220 may trigger a switch from the larger quantity of receive antennas to the reduced quantity of receive antennas (e.g., 4RX→2RX trigger) based on one or more trigger conditions. The one or more trigger conditions may be based on a type of implementation associated with the antenna manager 220. In some examples (e.g., in an ARD-physical downlink control channel (PDCCH) implementation), the antenna manager 220 may trigger the switch based on an expiration of an inactivity timer. In some examples (e.g., in an ARD-BWP implementation), the antenna manager 220 may trigger the switch based on the reduced quantity of receive antennas being associated with a default BWP. In some examples (e.g., in an ARD-physical downlink shared channel (PDSCH) implementation), the antenna manager 220 may trigger the switch based on a window-based downlink grant reception rate satisfying a threshold (e.g., a downlink grant reception rate being relatively low).

The antenna manager 220 may trigger a switch from the reduced quantity of receive antennas to the larger quantity of receive antennas (e.g., 2RX→4RX trigger) based on one or more trigger conditions. In some examples (e.g., in the ARD-PDCCH implementation), the antenna manager 220 may trigger the switch based on a reception of a downlink grant. In some examples (e.g., in the ARD-BWP implementation), the antenna manager 220 may trigger the switch based on the larger quantity of receive antennas being associated with a non-default BWP. In some examples (e.g., in the ARD-PDSCH implementation), the antenna manager 220 may trigger the switch based on a window-based downlink grant reception rate satisfying a threshold (e.g., a downlink grant reception rate being relatively high).

In the ARD-PDCCH implementation, there may be no power savings as long as downlink grants are frequently present. For example, an application 210 with low throughput that utilizes frequent downlink grants may trigger the antenna manager 220 to activate the larger quantity of receive antennas, even if the reduced quantity of receive antennas may support the reduced throughput. In the ARD-PDSCH implementation, the antenna manager 220 may support switching between the larger quantity of receive antennas to the reduced quantity of receive antennas (e.g., RX4→RX2) for a transient period. In some cases, the UE 115-a may report channel state feedback according to the reduced quantity of receive antennas (e.g., 2RX), while the UE 115-a may transmit sounding reference signal (SRS) via the larger quantity of antennas (e.g., 4RX).

For ARD-PDSCH designs a throughput of the UE 115-a and a grant reception rate may trigger antenna switching. For XR and gaming applications 210, the ARD-PDSCH may be enabled depending on if the UE 115 is in the low-latency mode (LLM). For example, the UE 115-a may disable the ARD if the LLM is enabled, and the UE 115-a may enable the ARD if the LLM is disabled.

According to techniques described herein, the antenna manager 220 may utilize enhanced ARD triggers that depend on UE traffic types, QoS or slicing configurations, and UE power requirements (e.g., power requirements for Redcap or wristwear devices). The enhanced ARD triggers may be employed in XR environments (e.g., where XR applications are executing at the UE 115-a or where XR data traffic is detected by the modem 215). The antenna manager 220 may provide power saving at the UE 115-a. The new ARD triggers (e.g., enhanced ARD triggers) for XR and wearables may ensure the performance and power requirements are met. The new ARD triggers may utilize relatively low-complexity signaling inside the UE 115-a and may exploit existing cross-layer application program interfaces (APIs) and the ARD implementation.

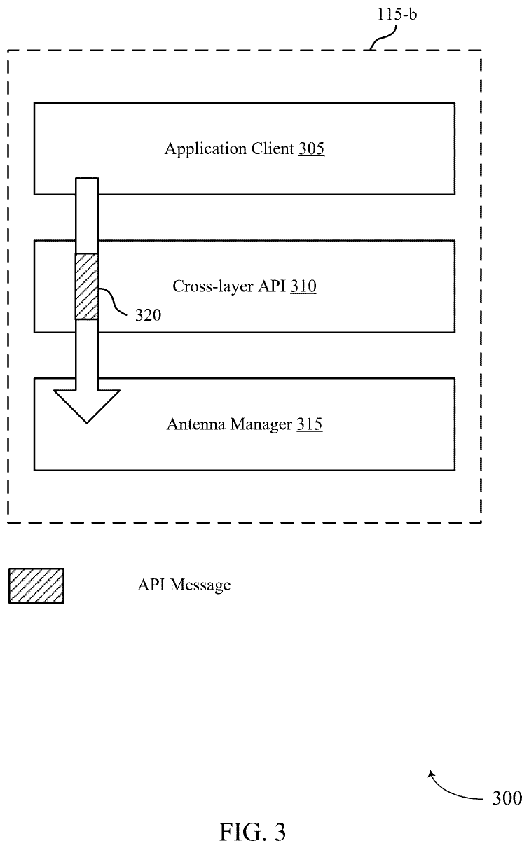

FIG. 3 shows an example of a UE diagram 300 that supports ARD trigger for XR in accordance with one or more aspects of the present disclosure. In some examples, UE diagram 300 may implement aspects of wireless communications system 100 and wireless communications system 200. For example, the UE diagram 300 may be implemented by a UE such as a UE 115-b, as described with reference to FIGS. 1 and 2. The UE 115-b may include an application client 305, a cross-layer API 310, and an antenna manager 315 (e.g., ARD manager). The application client 305 may run or execute an application (e.g., applications 210 as described with reference to FIG. 2). The cross-layer API 310 may be exposed to the application client 305 through a service layer of the UE 115-b. The UE 115-b and the antenna manager 315 may be examples of corresponding devices described with reference to FIGS. 1 and 2.

Applications executed at the UE 115-b may include different throughput and latency requirements to be accommodated by the antenna manager 315. For performance-sensitive application (e.g., applications with increased throughput and decreased latency requirements), the UE 115-b may disable the antenna manager 315 (e.g., such that all antennas are enabled continuously) or the antenna manager 315 may activate a relatively high quantity (e.g., all) antennas continuously. For applications that are not performance-sensitive the UE 115-b may enable the antenna manager 315 to manage switching between different quantities of antennas based on various triggers.

The application client 305 may signal an indication of one or more running applications or traffic performance requirements to the antenna manager 315 (e.g., the modem) via the cross-layer API 310 for ARD reconfiguration.

In some examples, the application client 305 may signal an API message 320 indicating one or more application types associated with one or more applications executing at the UE 115-b. The antenna manager 315 may activate a quantity of antennas based on the API message. For example, the antenna manager 315 may obtain an indication that a performance-sensitive application is being executed at the UE 115-b. The antenna manager 315 may activate one or more additional antennas to increase throughput and decrease latency for the performance-sensitive application.

In some examples, the application client 305 may signal the API message 320 indicating one or more performance requirements associated with one or more applications executed at the UE 115-b. The antenna manager 315 may activate a quantity of antennas to meet the performance requirements included in the API message 320.

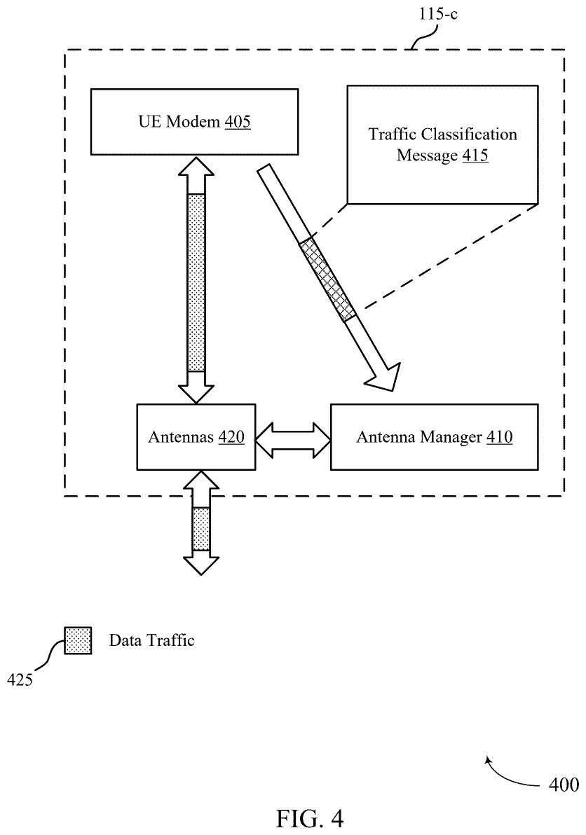

FIG. 4 shows an example of a UE diagram 400 that supports ARD trigger for XR in accordance with one or more aspects of the present disclosure. In some examples, UE diagram 400 may implement aspects of wireless communications system 100, wireless communications system 200, or UE diagram 300. For example, the UE diagram 400 may be implemented by a UE such as a UE 115-c, as described with reference to FIGS. 1-3. The UE 115-c may include a modem 405, an antenna manager 410, and antennas 420 (e.g., which may include a quantity of antennas such as 2 or 4 antennas). Each of the antennas 420 may have associated circuitry such as RFFE circuitry for reception or transmission of signals such as control information or data traffic 425. The antenna manager 410 (e.g., ARD manager) may be a component within the modem 405 or a separate component. The UE 115-c, the modem 405, and the antenna manager 410 may be examples of corresponding devices described with reference to FIGS. 1-3.

Data traffic 425 at the modem 405 may be analyzed for performance measurements (e.g., performance requirements) or traffic classification. For example, the modem 405 may implement an artificial intelligence (AI) or machine learning (ML) model to classify the data traffic 425 at the modem 405. The AI or ML model may input one or more measurements of the data traffic 425 and determine a traffic classification based on the one or more measurements.

The modem 405 may signal a traffic type to the antenna manager 410 via a traffic classification message 415. For example, the modem 405 may analyze the data traffic 425 at the modem 405, and the modem 405 may transmit an indication of a traffic type associated with the traffic data (e.g., performance-sensitive or not performance-sensitive as described with reference to FIG. 3). The antenna manager 410 may activate a quantity of antennas 420 based on the traffic type, as described with reference to FIG. 3.

The modem 405 may indicate whether application specific performance requirements are met to the antenna manager 410 via the traffic classification message 415. Additionally, or alternatively, the modem 405 may indicate by how much margin the application specific performance requirements are met (e.g., via the traffic classification message 415). The antenna manager 410 may activate a quantity of antennas based on whether the application specific performance requirements are met. For example, the antenna manager 410 may switch from the reduced quantity of receive antennas to the larger quantity of receive antennas (e.g., as described with reference to FIG. 2) to increase throughput or decrease latency if the application specific performance requirements are not being met.

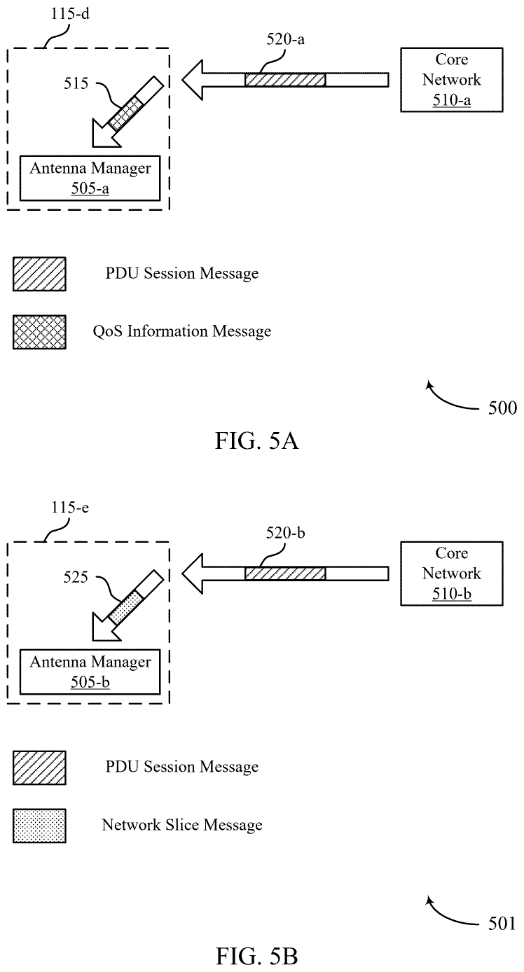

FIG. 5A shows an example of a wireless communications system 500 that supports ARD trigger for XR in accordance with one or more aspects of the present disclosure. In some examples, wireless communications system 500 may implement aspects of wireless communications system 100, wireless communications system 200, UE diagram 300, or UE diagram 400. For example, the wireless communications system 500 may include a UE such as a UE 115-d, as described with reference to FIGS. 1-4. The UE 115-d may include an antenna manager 505-a (e.g., ARD). The UE 115-d and the antenna manager 505-a may be examples of corresponding devices described with reference to FIGS. 1-4.

The UE 115-d may be in communication with an application server (e.g., an application server in a core network 510-a). The core network 510-a may signal QoS information to the UE 115-d via a packet data unit (PDU) session message 520-a. The PDU session message 520-a may be an example of a PDU session establishment message or a PDU session modification message. The QoS information may be relayed (e.g., by a modem in the4 UE 115-d) to the antenna manager 505-a. In some examples, the UE 115-d may determine whether to activate the antenna manager 505-a. Additionally, or alternatively, the antenna manager 505-a may determine how many antennas to activate (e.g., turn on) when the antenna manager 505-a is activated.

For example, the antenna manager 505-a may obtain a QoS information message 515, and the antenna manager 505-a may determine a quantity of antennas to activate based on the QoS information indicated by the QoS information message 515.

FIG. 5B shows an example of a wireless communications system 501 that supports ARD trigger for XR in accordance with one or more aspects of the present disclosure. In some examples, wireless communications system 501 may implement aspects of wireless communications system 100, wireless communications system 200, UE diagram 300, UE diagram 400, or wireless communications system 500. For example, the wireless communications system 501 may include a UE such as a UE 115-e, as described with reference to FIGS. 1-5A . The UE 115-e may include an antenna manager 505-b (e.g., ARD manager). The UE 115-e and the antenna manager 505-b may be examples of corresponding devices described with reference to FIGS. 1-5A.

The UE 115-e may be in communication with an application server (e.g., an application server in a core network 510-a). The core network 510-b may signal a network slice to the UE 115-e via a PDU session message 520-b. The PDU session message 520-b may be an example of a PDU session establishment message or a PDU session modification message. The network slice may be configured to serve the UE 115-e by the core network 510-b, or may be associated with a subscription of the UE 115-e. The slicing information may be relayed to the antenna manager 505-b (e.g., by a modem of the UE 115-e). For a low-latency slice or a slice associated with a relatively high QoS, the UE 115-e may disable the antenna manager 505-b, or the antenna manager 505-b may be activated and the antenna manager 505-b may activate a relatively higher quantity of (e.g., all) UE antennas. For a default slice, the UE 115-e may enable the antenna manager 505-b, and the antenna manager 505-b may activate a relatively lower quantity of UE antennas (e.g., may deactivate one or more UE antennas).

For example, the antenna manager 505-b may obtain a network slice message 525, and the antenna manager 505-b may activate a quantity of antennas based on the type of network slice (e.g., higher quantity of antennas for low-latency or high-QoS slices, or lower quantity of antennas for a default slice) indicated by the network slice message 525.

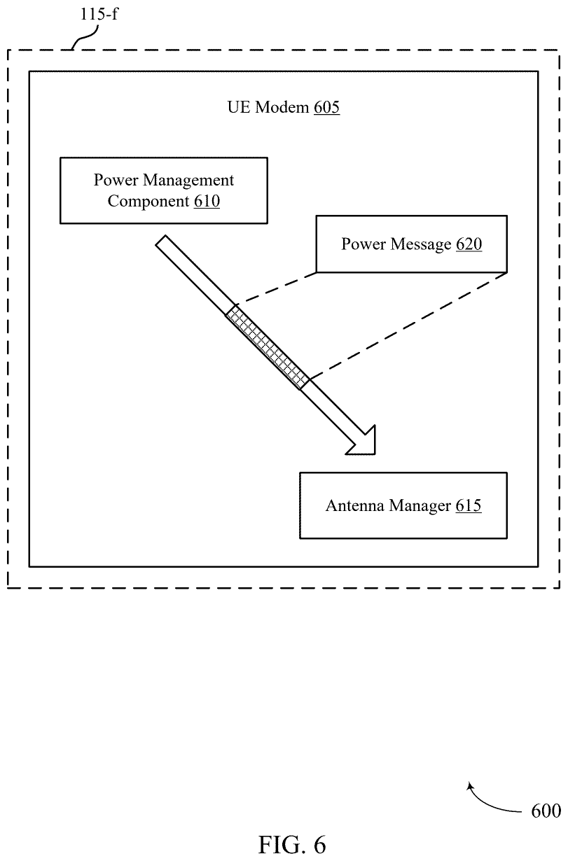

FIG. 6 shows an example of a UE diagram 600 that supports ARD trigger for XR in accordance with one or more aspects of the present disclosure. In some examples, UE diagram 600 may implement aspects of wireless communications system 100, wireless communications system 200, UE diagram 300, UE diagram 400, wireless communications system 500, or wireless communications systems 501. For example, the UE diagram 600 may be implemented by a UE such as a UE 115-f, as described with reference to FIGS. 1-5B . The UE 115-f may include a modem 605. In some examples, the modem 605 may include a power management component 610 and an antenna manager 615 (e.g., ARD manager). In some examples, the antenna manager 615 may be a separate component not within the modem 605. The UE 115-f, the modem 605, and the antenna manager 615 may be examples of corresponding devices described with reference to FIGS. 1-5B.

The power management component 610 may signal an indication of UE power consumption to the antenna manager 615 (e.g., via a power message 620). Additionally, or alternatively, the power management component 610 may signal (e.g., via the power message 620) an indication of whether a UE power budget is met to the antenna manager 615. The UE 115-f may enable the antenna manager 615 (e.g., which may disable one or more UE antennas) based on whether the UE power budget satisfies a threshold (e.g., is met with margins). For example, the antenna manager 615 may deactivate one or more antennas if the UE power budget is not being met to decrease power consumption at the UE 115-f. The power management component 610 may measure RFFE power data at the modem 605.

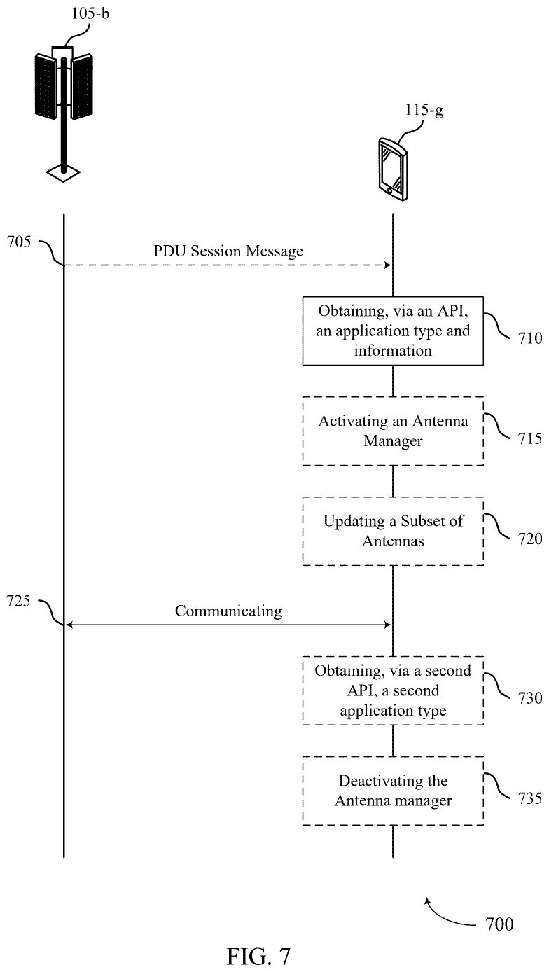

FIG. 7 shows an example of a process flow 700 that supports ARD trigger for XR in accordance with one or more aspects of the present disclosure. In some examples, process flow 700 may implement aspects of wireless communications system 100, wireless communications system 200, UE diagram 300, UE diagram 400, wireless communications system 500, wireless communications systems 501, or UE diagram 600. For example, the process flow 700 may include a UE 115-g and a network entity 105-b which may be examples of corresponding devices described with reference to FIGS. 1-6.

In some cases, at 705, the UE 115-g may receive an indication of QoS information via a PDU session establishment message or a PDU session modification message (e.g., as described with reference to FIG. 5A). In some cases, at 705, the UE 115-g may receive an indication of a network slice via a PDU session establishment message or a PDU session modification message (e.g., as described with reference to FIG. 5B). The indication of the network slice may indicate a type of the network slice.

At 710, the UE 115-g may obtain, via an API, an indication of an application type of an application at the UE and information including an indication of performance requirements associated with the application, an indication of a traffic type associated with the application, an indication of whether the performance requirements are being met, an indication of QoS information associated with a PDU session established for communication by the application, an indication of a network slice associated with the PDU session, an indication of a power consumption of the UE 115-g, an indication of whether a power budget of the UE 115-g is being met, or any combination thereof. In some cases, the performance requirements associated with the application may include a throughput threshold or a latency threshold. In some cases, the UE may be associated with multiple applications including the application. The application may be associated with a highest resource utilization of the multiple applications.

In some cases, the UE 115-g may obtain, at an antenna manager via an interface established by the antenna manager, the indication of the application type or the indication of the performance requirements from the application (e.g., as described with reference to FIG. 3). In some cases, the UE 115-g may obtain, from a modem of the UE 115-g, the indication of the traffic type or the indication of whether the performance requirements are being met based on a metric associated with data traffic at the modem (e.g., as described with reference to FIG. 4). In some cases, the UE 115-g may obtain, from a modem of the UE 115-g, the indication of the power consumption of the UE or the indication of whether the power budget of the UE is being met (e.g., as described with reference to FIG. 6).

In some cases, at 715, the UE 115-g may activate an antenna manager based on the indication of the QoS information or based on the type of network slice. In some cases, at 715, the UE 115-g may activate an antenna manager based on the application type being associated with an XR environment.

At 720, the UE 115-g may update, based on the performance requirements not being met, the subset of the multiple antennas to include one or more additional activated antennas.

At 725, the UE 115-g may communicate one or more wireless signals (e.g., with the network entity 105-b) via a subset of multiple antennas of the UE 115-g. The subset of multiple antennas may be activated for communication of the one or more wireless signals based on the application type being associated with the XR environment and the information.

In some cases, communicating the one or more wireless signals via the subset of the multiple antennas may be based on activation of the antenna manager. In some cases, communicating the one or more wireless signals may be based on updating the subset of the multiple antennas.

At 730, the UE 115-g may obtain, via the API, an indication of a second application type of a second application at the UE 115-g.

At 735, the UE 115-g may deactivate the antenna manager for communication of one or more second signals associated with the second application based on the second application type being associated with a non-XR environment.

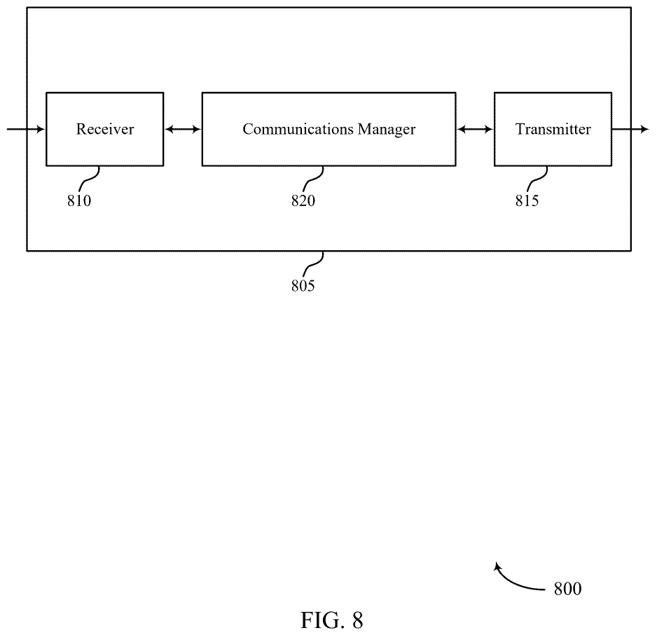

FIG. 8 shows a block diagram 800 of a device 805 that supports ARD trigger for XR in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to ARD trigger for XR). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to ARD trigger for XR). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of ARD trigger for XR as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for obtaining, via an API, an indication of an application type of an application at the UE and information including an indication of performance requirements associated with the application, an indication of a traffic type associated with the application, an indication of whether the performance requirements are being met, an indication of QoS information associated with a PDU session established for communication by the application, an indication of a network slice associated with the PDU session, an indication of a power consumption of the UE, an indication of whether a power budget of the UE is being met, or any combination thereof. The communications manager 820 is capable of, configured to, or operable to support a means for communicating one or more wireless signals via a subset of a set of multiple antennas of the UE, where the subset of the set of multiple antennas is activated for communication of the one or more wireless signals based on the application type being associated with an XR environment and the information.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced power consumption and the like.

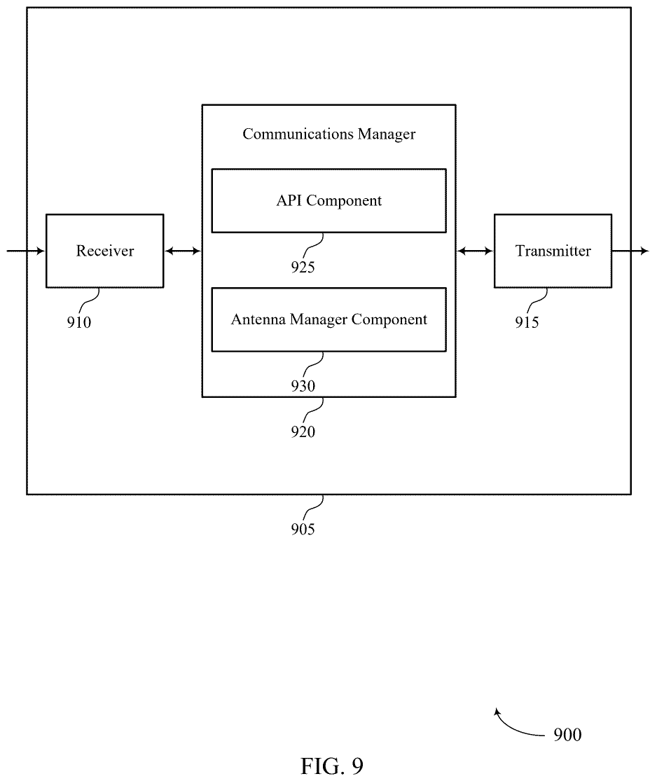

FIG. 9 shows a block diagram 900 of a device 905 that supports ARD trigger for XR in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to ARD trigger for XR). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to ARD trigger for XR). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of ARD trigger for XR as described herein. For example, the communications manager 920 may include an API component 925 an antenna manager component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The API component 925 is capable of, configured to, or operable to support a means for obtaining, via an API, an indication of an application type of an application at the UE and information including an indication of performance requirements associated with the application, an indication of a traffic type associated with the application, an indication of whether the performance requirements are being met, an indication of QoS information associated with a PDU session established for communication by the application, an indication of a network slice associated with the PDU session, an indication of a power consumption of the UE, an indication of whether a power budget of the UE is being met, or any combination thereof. The antenna manager component 930 is capable of, configured to, or operable to support a means for communicating one or more wireless signals via a subset of a set of multiple antennas of the UE, where the subset of the set of multiple antennas is activated for communication of the one or more wireless signals based on the application type being associated with an XR environment and the information.

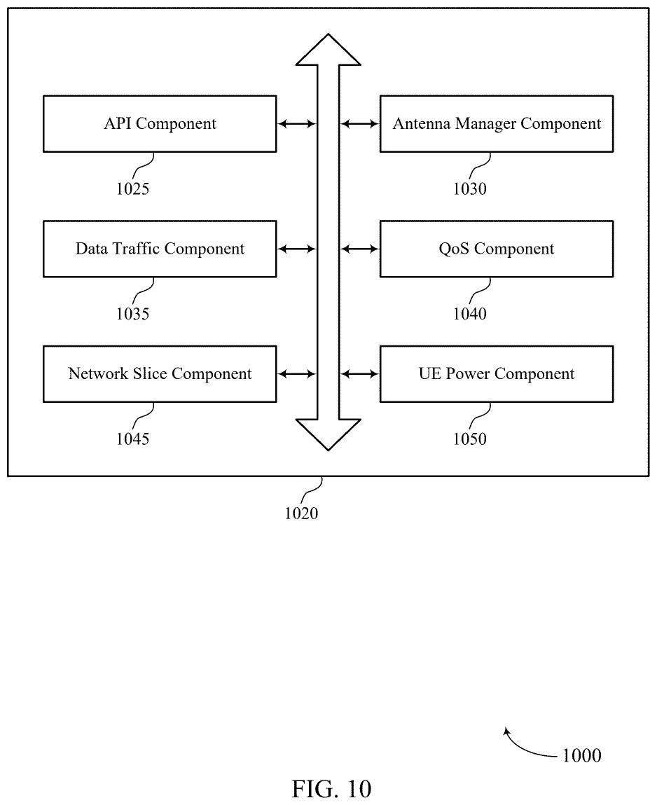

FIG. 10 shows a block diagram 1000 of a communications manager 1020 that supports ARD trigger for XR in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of ARD trigger for XR as described herein. For example, the communications manager 1020 may include an API component 1025, an antenna manager component 1030, a data traffic component 1035, a QoS component 1040, a network slice component 1045, a UE power component 1050, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The API component 1025 is capable of, configured to, or operable to support a means for obtaining, via an API, an indication of an application type of an application at the UE and information including an indication of performance requirements associated with the application, an indication of a traffic type associated with the application, an indication of whether the performance requirements are being met, an indication of QoS information associated with a PDU session established for communication by the application, an indication of a network slice associated with the PDU session, an indication of a power consumption of the UE, an indication of whether a power budget of the UE is being met, or any combination thereof. The antenna manager component 1030 is capable of, configured to, or operable to support a means for communicating one or more wireless signals via a subset of a set of multiple antennas of the UE, where the subset of the set of multiple antennas is activated for communication of the one or more wireless signals based on the application type being associated with an XR environment and the information.

In some examples, to support obtaining the indication of the application type and the information, the antenna manager component 1030 is capable of, configured to, or operable to support a means for obtaining, at an antenna manager via an interface established by the antenna manager, the indication of the application type or the indication of the performance requirements from the application.

In some examples, the performance requirements associated with the application include a throughput threshold or a latency threshold.

In some examples, to support obtaining the information, the data traffic component 1035 is capable of, configured to, or operable to support a means for obtaining, from a modem of the UE, the indication of the traffic type or the indication of whether the performance requirements are being met based on a metric associated with data traffic at the modem.

In some examples, the antenna manager component 1030 is capable of, configured to, or operable to support a means for updating, based on the performance requirements not being met, the subset of the set of multiple antennas to include one or more additional activated antennas, where communicating the one or more wireless signals is based on updating the subset of the set of multiple antennas.

In some examples, to support obtaining the information, the QoS component 1040 is capable of, configured to, or operable to support a means for receiving the indication of the QoS information via a PDU session establishment message or a PDU session modification message.

In some examples, the antenna manager component 1030 is capable of, configured to, or operable to support a means for activating an antenna manager based on the indication of the QoS information, where communicating the one or more wireless signals via the subset of the set of multiple antennas is based on activation of the antenna manager.

In some examples, to support obtaining the information, the network slice component 1045 is capable of, configured to, or operable to support a means for receiving the indication of the network slice via a PDU session establishment message or a PDU session modification message, where the indication of the network slice indicates a type of the network slice.

In some examples, the antenna manager component 1030 is capable of, configured to, or operable to support a means for activating an antenna manager based on the type of the network slice, where communicating the one or more wireless signals is based on activation of the antenna manager.

In some examples, to support obtaining the information, the UE power component 1050 is capable of, configured to, or operable to support a means for obtaining, from a modem of the UE, the indication of the power consumption of the UE or the indication of whether the power budget of the UE is being met.

In some examples, the UE is associated with a set of multiple applications including the application. In some examples, the application is associated with a highest resource utilization of the set of multiple applications.

In some examples, the antenna manager component 1030 is capable of, configured to, or operable to support a means for activating an antenna manager based on the application type being associated with the XR environment. In some examples, the API component 1025 is capable of, configured to, or operable to support a means for obtaining, via a second API, an indication of a second application type of a second application at the UE. In some examples, the antenna manager component 1030 is capable of, configured to, or operable to support a means for deactivating the antenna manager for communication of one or more second signals associated with the second application based on the second application type being associated with a non-XR environment.

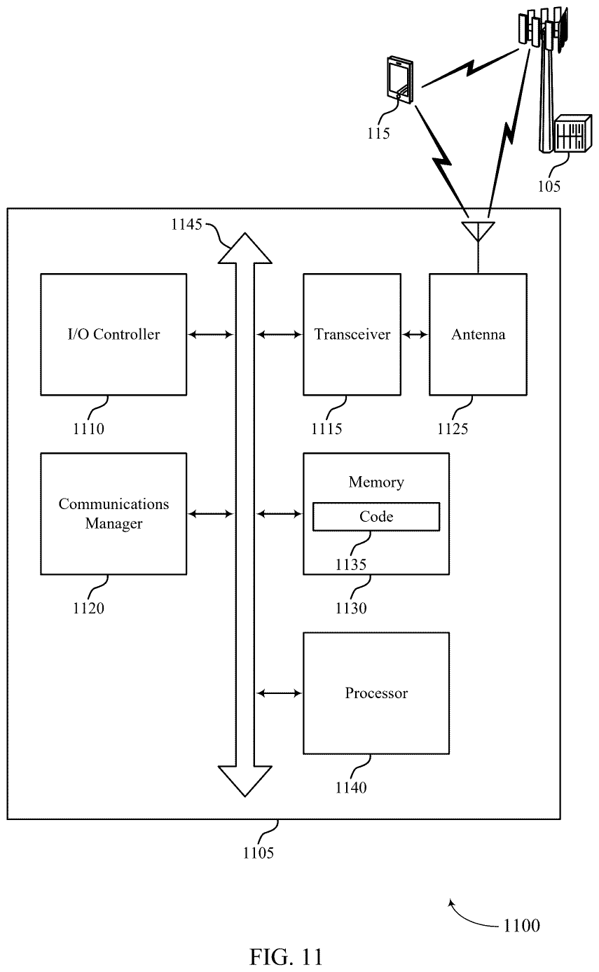

FIG. 11 shows a diagram of a system 1100 including a device 1105 that supports ARD trigger for XR in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting ARD trigger for XR). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for obtaining, via an API, an indication of an application type of an application at the UE and information including an indication of performance requirements associated with the application, an indication of a traffic type associated with the application, an indication of whether the performance requirements are being met, an indication of QoS information associated with a PDU session established for communication by the application, an indication of a network slice associated with the PDU session, an indication of a power consumption of the UE, an indication of whether a power budget of the UE is being met, or any combination thereof. The communications manager 1120 is capable of, configured to, or operable to support a means for communicating one or more wireless signals via a subset of a set of multiple antennas of the UE, where the subset of the set of multiple antennas is activated for communication of the one or more wireless signals based on the application type being associated with an XR environment and the information.

By including or configuring the communications manager 1120 in accordance with examples as described herein, the device 1105 may support techniques for reduced latency, reduced power consumption, longer battery life, and the like.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of ARD trigger for XR as described herein, or the at least one processor 1140 and the at least one memory 1130 may be otherwise configured to, individually or collectively, perform or support such operations.

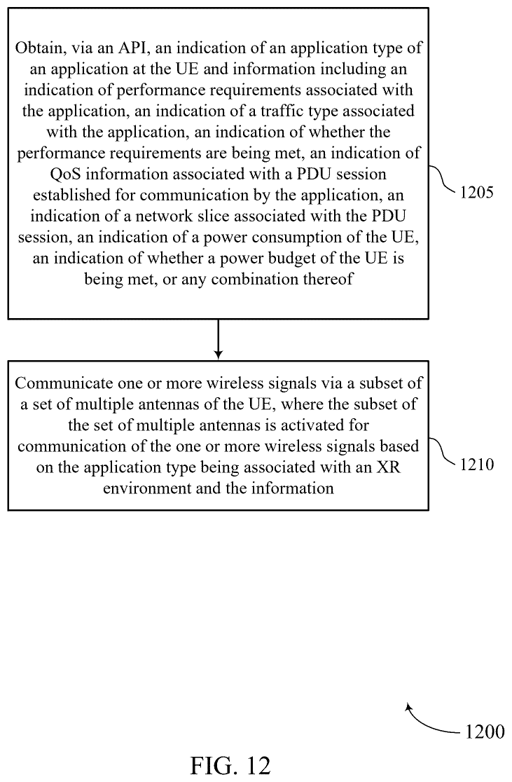

FIG. 12 shows a flowchart illustrating a method 1200 that supports ARD trigger for XR in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include obtaining, via an API, an indication of an application type of an application at the UE and information including an indication of performance requirements associated with the application, an indication of a traffic type associated with the application, an indication of whether the performance requirements are being met, an indication of QoS information associated with a PDU session established for communication by the application, an indication of a network slice associated with the PDU session, an indication of a power consumption of the UE, an indication of whether a power budget of the UE is being met, or any combination thereof. The operations of 1205 may be performed in accordance with examples as disclosed herein, such as disclosed in operation 710 of FIG. 7. In some examples, aspects of the operations of 1205 may be performed by an API component 1025 as described with reference to FIG. 10. In some examples, aspects of the operations of 1205 may be performed by the at least one memory 1130 or the at least one processor 1140, as described with reference to FIG. 11.

At 1210, the method may include communicating one or more wireless signals via a subset of a set of multiple antennas of the UE, where the subset of the set of multiple antennas is activated for communication of the one or more wireless signals based on the application type being associated with an XR environment and the information. The operations of 1210 may be performed in accordance with examples as disclosed herein, such as disclosed in operation 725 of FIG. 7. In some examples, aspects of the operations of 1210 may be performed by an antenna manager component 1030 as described with reference to FIG. 10. In some examples, aspects of the operations of 1210 may be performed by the at least one memory 1130 or the at least one processor 1140, as described with reference to FIG. 11.

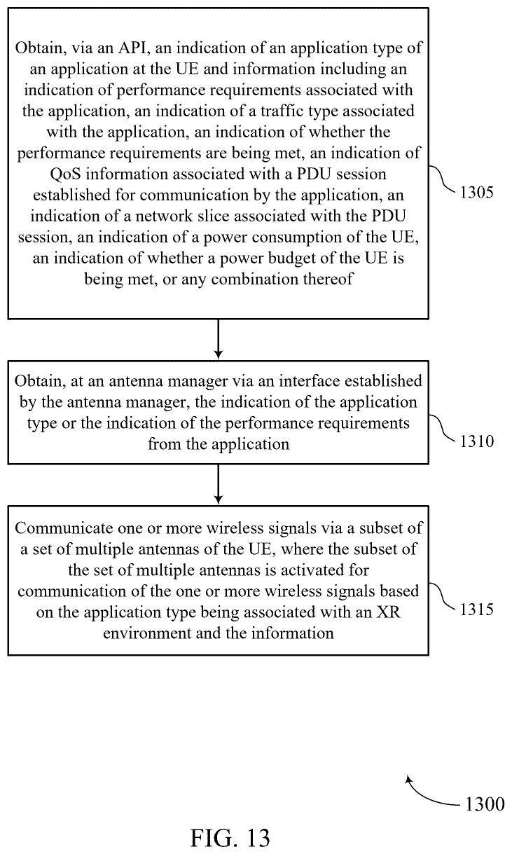

FIG. 13 shows a flowchart illustrating a method 1300 that supports ARD trigger for XR in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include obtaining, via an API, an indication of an application type of an application at the UE and information including an indication of performance requirements associated with the application, an indication of a traffic type associated with the application, an indication of whether the performance requirements are being met, an indication of QoS information associated with a PDU session established for communication by the application, an indication of a network slice associated with the PDU session, an indication of a power consumption of the UE, an indication of whether a power budget of the UE is being met, or any combination thereof. The operations of 1305 may be performed in accordance with examples as disclosed herein, such as disclosed in operation 710 of FIG. 7. In some examples, aspects of the operations of 1305 may be performed by an API component 1025 as described with reference to FIG. 10. In some examples, aspects of the operations of 1305 may be performed by the at least one memory 1130 or the at least one processor 1140, as described with reference to FIG. 11.

At 1310, the method may include obtaining, at an antenna manager via an interface established by the antenna manager, the indication of the application type or the indication of the performance requirements from the application. The operations of 1310 may be performed in accordance with examples as disclosed herein, such as disclosed in operation 710 of FIG. 7 and the API message of FIG. 3. In some examples, aspects of the operations of 1310 may be performed by an antenna manager component 1030 as described with reference to FIG. 10. In some examples, aspects of the operations of 1310 may be performed by the at least one memory 1130 or the at least one processor 1140, as described with reference to FIG. 11.

At 1315, the method may include communicating one or more wireless signals via a subset of a set of multiple antennas of the UE, where the subset of the set of multiple antennas is activated for communication of the one or more wireless signals based on the application type being associated with an XR environment and the information. The operations of 1315 may be performed in accordance with examples as disclosed herein, such as disclosed in operation 725 of FIG. 7. In some examples, aspects of the operations of 1315 may be performed by an antenna manager component 1030 as described with reference to FIG. 10. In some examples, aspects of the operations of 1315 may be performed by the at least one memory 1130 or the at least one processor 1140, as described with reference to FIG. 11.

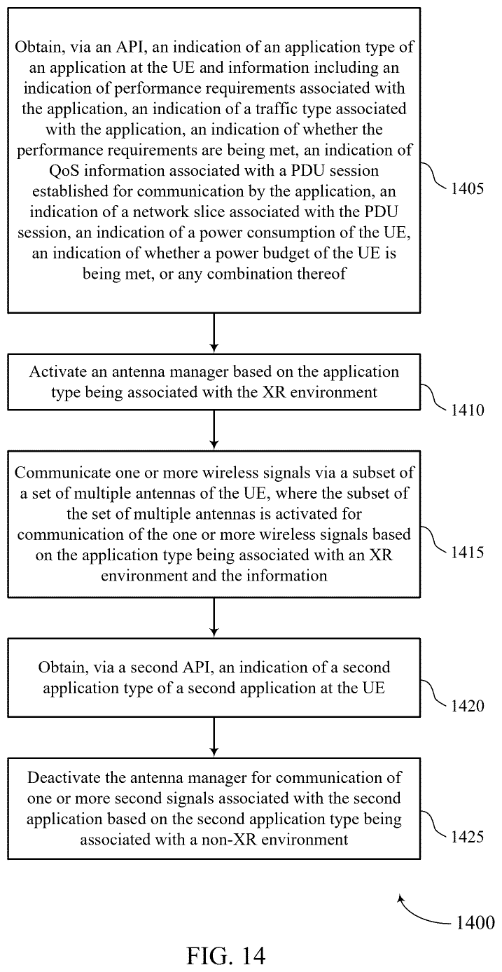

FIG. 14 shows a flowchart illustrating a method 1400 that supports ARD trigger for XR in accordance with one or more aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1405, the method may include obtaining, via an API, an indication of an application type of an application at the UE and information including an indication of performance requirements associated with the application, an indication of a traffic type associated with the application, an indication of whether the performance requirements are being met, an indication of QoS information associated with a PDU session established for communication by the application, an indication of a network slice associated with the PDU session, an indication of a power consumption of the UE, an indication of whether a power budget of the UE is being met, or any combination thereof. The operations of 1405 may be performed in accordance with examples as disclosed herein, such as disclosed in operation 710 of FIG. 7. In some examples, aspects of the operations of 1405 may be performed by an API component 1025 as described with reference to FIG. 10. In some examples, aspects of the operations of 1405 may be performed by the at least one memory 1130 or the at least one processor 1140, as described with reference to FIG. 11.

At 1410, the method may include activating an antenna manager based on the application type being associated with the XR environment. The operations of 1410 may be performed in accordance with examples as disclosed herein, such as disclosed in operation 715 of FIG. 7. In some examples, aspects of the operations of 1410 may be performed by an antenna manager component 1030 as described with reference to FIG. 10. In some examples, aspects of the operations of 1410 may be performed by the at least one memory 1130 or the at least one processor 1140, as described with reference to FIG. 11.

At 1415, the method may include communicating one or more wireless signals via a subset of a set of multiple antennas of the UE, where the subset of the set of multiple antennas is activated for communication of the one or more wireless signals based on the application type being associated with an XR environment and the information. The operations of 1415 may be performed in accordance with examples as disclosed herein, such as disclosed in operation 725 of FIG. 7. In some examples, aspects of the operations of 1415 may be performed by an antenna manager component 1030 as described with reference to FIG. 10. In some examples, aspects of the operations of 1415 may be performed by the at least one memory 1130 or the at least one processor 1140, as described with reference to FIG. 11.

At 1420, the method may include obtaining, via a second API, an indication of a second application type of a second application at the UE. The operations of 1420 may be performed in accordance with examples as disclosed herein, such as disclosed in operation 730 of FIG. 7. In some examples, aspects of the operations of 1420 may be performed by an API component 1025 as described with reference to FIG. 10. In some examples, aspects of the operations of 1420 may be performed by the at least one memory 1130 or the at least one processor 1140, as described with reference to FIG. 11.

At 1425, the method may include deactivating the antenna manager for communication of one or more second signals associated with the second application based on the second application type being associated with a non-XR environment. The operations of 1425 may be performed in accordance with examples as disclosed herein, such as disclosed in operation 735 of FIG. 7. In some examples, aspects of the operations of 1425 may be performed by an antenna manager component 1030 as described with reference to FIG. 10. In some examples, aspects of the operations of 1425 may be performed by the at least one memory 1130 or the at least one processor 1140, as described with reference to FIG. 11.

The following provides an overview of aspects of the present disclosure:

Aspect 1: A method by a UE, comprising: obtaining, via an API, an indication of an application type of an application at the UE and information including an indication of performance requirements associated with the application, an indication of a traffic type associated with the application, an indication of whether the performance requirements are being met, an indication of QoS information associated with a PDU session established for communication by the application, an indication of a network slice associated with the PDU session, an indication of a power consumption of the UE, an indication of whether a power budget of the UE is being met, or any combination thereof; and communicating one or more wireless signals via a subset of a plurality of antennas of the UE, wherein the subset of the plurality of antennas is activated for communication of the one or more wireless signals based at least in part on the application type being associated with an XR environment and the information.

Aspect 2: The method of aspect 1, wherein to obtaining the indication of the application type and the information further comprises: obtaining, at an antenna manager via an interface established by the antenna manager, the indication of the application type or the indication of the performance requirements from the application.

Aspect 3: The method of any of aspects 1 through 2, wherein the performance requirements associated with the application comprise a throughput threshold or a latency threshold.

Aspect 4: The method of any of aspects 1 through 3, wherein to obtaining the information further comprises: obtaining, from a modem of the UE, the indication of the traffic type or the indication of whether the performance requirements are being met based at least in part on a metric associated with data traffic at the modem.

Aspect 5: The method of aspect 4, further comprising: updating, based at least in part on the performance requirements not being met, the subset of the plurality of antennas to include one or more additional activated antennas, wherein communicating the one or more wireless signals is based at least in part on updating the subset of the plurality of antennas.

Aspect 6: The method of any of aspects 1 through 5, wherein to obtaining the information further comprises: receiving the indication of the QoS information via a PDU session establishment message or a PDU session modification message.

Aspect 7: The method of aspect 6, further comprising: activating an antenna manager based at least in part on the indication of the QoS information, wherein communicating the one or more wireless signals via the subset of the plurality of antennas is based at least in part on activation of the antenna manager.

Aspect 8: The method of any of aspects 1 through 7, wherein to obtaining the information further comprises: receiving the indication of the network slice via a PDU session establishment message or a PDU session modification message, wherein the indication of the network slice indicates a type of the network slice.

Aspect 9: The method of aspect 8, further comprising: activating an antenna manager based at least in part on the type of the network slice, wherein communicating the one or more wireless signals is based at least in part on activation of the antenna manager.

Aspect 10: The method of any of aspects 1 through 9, wherein to obtaining the information further comprises: obtaining, from a modem of the UE, the indication of the power consumption of the UE or the indication of whether the power budget of the UE is being met.

Aspect 11: The method of any of aspects 1 through 10, wherein the UE is associated with a plurality of applications comprising the application, and the application is associated with a highest resource utilization of the plurality of applications.

Aspect 12: The method of any of aspects 1 through 11, further comprising: activating an antenna manager based at least in part on the application type being associated with the XR environment; obtaining, via a second API, an indication of a second application type of a second application at the UE; and deactivating the antenna manager for communication of one or more second signals associated with the second application based at least in part on the second application type being associated with a non-XR environment.

Aspect 13: A UE comprising one or more memories storing processor-executable code, and one or more processors coupled with the one or more memories and individually or collectively operable to execute the code to cause the UE to perform a method of any of aspects 1 through 12.

Aspect 14: A UE comprising at least one means for performing a method of any of aspects 1 through 12.

Aspect 15: A non-transitory computer-readable medium storing code the code comprising instructions executable by one or more processors to perform a method of any of aspects 1 through 12.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
obtain, via an application program interface, an indication of an application type of an application at the UE and information including an indication of performance requirements associated with the application, an indication of a traffic type associated with the application, an indication of whether the performance requirements are being met, an indication of quality of service (QoS) information associated with a packet data unit (PDU) session established for communication by the application, an indication of a network slice associated with the PDU session, an indication of a power consumption of the UE, an indication of whether a power budget of the UE is being met, or any combination thereof; and
communicate one or more wireless signals via a subset of a plurality of antennas of the UE, wherein the subset of the plurality of antennas is activated for communication of the one or more wireless signals based at least in part on the application type being associated with an extended reality (XR) environment and the information.

2. The UE of claim 1, wherein, to obtain the indication of the application type and the information, the one or more processors are individually or collectively further operable to execute the code to cause the UE to:
obtain, at an antenna manager via an interface established by the antenna manager, the indication of the application type or the indication of the performance requirements from the application.

3. The UE of claim 1, wherein the performance requirements associated with the application comprise a throughput threshold or a latency threshold.

4. The UE of claim 1, wherein, to obtain the information, the one or more processors are individually or collectively further operable to execute the code to cause the UE to:
obtain, from a modem of the UE, the indication of the traffic type or the indication of whether the performance requirements are being met based at least in part on a metric associated with data traffic at the modem.

5. The UE of claim 4, wherein the one or more processors are individually or collectively further operable to execute the code to cause the UE to:
updating, based at least in part on the performance requirements not being met, the subset of the plurality of antennas to include one or more additional activated antennas, wherein communicating the one or more wireless signals is based at least in part on updating the subset of the plurality of antennas.

6. The UE of claim 1, wherein, to obtain the information, the one or more processors are individually or collectively further operable to execute the code to cause the UE to:
receive the indication of the QoS information via a PDU session establishment message or a PDU session modification message.

7. The UE of claim 6, wherein the one or more processors are individually or collectively further operable to execute the code to cause the UE to:
activate an antenna manager based at least in part on the indication of the QoS information, wherein communicating the one or more wireless signals via the subset of the plurality of antennas is based at least in part on activation of the antenna manager.

8. The UE of claim 1, wherein, to obtain the information, the one or more processors are individually or collectively further operable to execute the code to cause the UE to:
receive the indication of the network slice via a PDU session establishment message or a PDU session modification message, wherein the indication of the network slice indicates a type of the network slice.

9. The UE of claim 8, wherein the one or more processors are individually or collectively further operable to execute the code to cause the UE to:
activate an antenna manager based at least in part on the type of the network slice, wherein communicating the one or more wireless signals is based at least in part on activation of the antenna manager.

10. The UE of claim 1, wherein, to obtain the information, the one or more processors are individually or collectively further operable to execute the code to cause the UE to:
obtain, from a modem of the UE, the indication of the power consumption of the UE or the indication of whether the power budget of the UE is being met.

11. The UE of claim 1, wherein:
the UE is associated with a plurality of applications comprising the application, and
the application is associated with a highest resource utilization of the plurality of applications.

12. The UE of claim 1, wherein the one or more processors are individually or collectively further operable to execute the code to cause the UE to:
activate an antenna manager based at least in part on the application type being associated with the XR environment;
obtain, via a second application program interface, an indication of a second application type of a second application at the UE; and
deactivate the antenna manager for communication of one or more second signals associated with the second application based at least in part on the second application type being associated with a non-XR environment.

13. A method for wireless communications at a user equipment (UE), comprising:
obtaining, via an application program interface, an indication of an application type of an application at the UE and information including an indication of performance requirements associated with the application, an indication of a traffic type associated with the application, an indication of whether the performance requirements are being met, an indication of quality of service (QoS) information associated with a packet data unit (PDU) session established for communication by the application, an indication of a network slice associated with the PDU session, an indication of a power consumption of the UE, an indication of whether a power budget of the UE is being met, or any combination thereof; and
communicating one or more wireless signals via a subset of a plurality of antennas of the UE, wherein the subset of the plurality of antennas is activated for communication of the one or more wireless signals based at least in part on the application type being associated with an extended reality (XR) environment and the information.

14. The method of claim 13, wherein obtaining the indication of the application type and the information further comprises:
obtaining, at an antenna manager via an interface established by the antenna manager, the indication of the application type or the indication of the performance requirements from the application.

15. The method of claim 13, wherein the performance requirements associated with the application comprise a throughput threshold or a latency threshold.

16. The method of claim 13, wherein obtaining the information further comprises:
obtaining, from a modem of the UE, the indication of the traffic type or the indication of whether the performance requirements are being met based at least in part on a metric associated with data traffic at the modem.

17. The method of claim 13, wherein obtaining the information further comprises:
receiving the indication of the QoS information via a PDU session establishment message or a PDU session modification message.

18. The method of claim 13, wherein obtaining the information further comprises:
receiving the indication of the network slice via a PDU session establishment message or a PDU session modification message, wherein the indication of the network slice indicates a type of the network slice.

19. The method of claim 13, further comprising:
activating an antenna manager based at least in part on the application type being associated with the XR environment;
obtaining, via a second application program interface, an indication of a second application type of a second application at the UE; and
deactivating the antenna manager for communication of one or more second signals associated with the second application based at least in part on the second application type being associated with a non-XR environment.

20. A non-transitory computer-readable medium storing code for wireless communications, the code comprising instructions executable by one or more processors to:
obtain, via an application program interface, an indication of an application type of an application at a user equipment (UE) and information including an indication of performance requirements associated with the application, an indication of a traffic type associated with the application, an indication of whether the performance requirements are being met, an indication of quality of service (QoS) information associated with a packet data unit (PDU) session established for communication by the application, an indication of a network slice associated with the PDU session, an indication of a power consumption of the UE, an indication of whether a power budget of the UE is being met, or any combination thereof; and
communicate one or more wireless signals via a subset of a plurality of antennas of the UE, wherein the subset of the plurality of antennas is activated for communication of the one or more wireless signals based at least in part on the application type being associated with an extended reality (XR) environment and the information.
